(19) United States
(12) Patent Application Publication
(10) Pub. No.: US 2026/0029640 A1
(43) Pub. Date: Jan. 29, 2026

(54) ADAPTIVE BEAM COLLIMATION AND QUALITY OPTIMIZATION SYSTEM AND METHOD BASED ON SPOT GRIDDING

(71) Applicant: Hefei Institutes of Physical Sciences, Chinese Academy of Sciences, Hefei, Anhui (CN)

(72) Inventors: ShuMei XIAO, Hefei, Anhui (CN); Qing ZANG, Hefei, Anhui (CN); XiaoFeng HAN, Hefei, Anhui (CN)

(21) Appl. No.: 19/260,082

(22) Filed: Jul. 3, 2025

(30) Foreign Application Priority Data
Jul. 26, 2024 (CN) 202411009795.2

(51) Int. Cl. G02B 26/08; G02B 27/30

(52) U.S. Cl. CPC G02B 26/0858; G02B 27/30

(57) ABSTRACT

The present disclosure discloses an adaptive beam collimation and quality optimization system and method based on spot gridding, which belongs to the field of laser transmission. In the adaptive beam collimation and quality optimization system, a first optical reflector is installed at the front end of a three-module optical mirror frame, and an incident laser beam is reflected by a first optical reflector to reach a second optical reflector, and then the beam is output after being reflected by the second optical reflector again; an image collector collects a spot image on the second optical reflector and stores it to a computer; a computer processes the collected spot image, extracts a real-time relative position of the spot on the second optical reflector, compares the real-time relative position information with a pre-calibrated position to obtain the offset of the spot, correct the offset of the reflected beam, and feedback the intensity information of the adjacent small unit spot to a spot unit piezoelectric ceramic array module controller to correct the distortion of the reflected beam. The present disclosure can realize adaptive beam collimation and spot optimization without manual guarding and operation, and is applicable to the collimation and spot optimization of large-diameter beam transmission.

### BACKGROUND

### Technical Field

The present disclosure belongs to the field of laser transmission, and specifically relates to adaptive beam collimation and quality optimization system and method based on spot gridding.

### Description of the Related Art

Optical measurement, starry sky observation, laser diagnostics and many other fields all need to use laser beams to measure signals. The beam is affected by many unpredictable factors such as surface roughness of optical components, temperature, humidity and cleanness of air, atmospheric turbulence, aerosol, etc., in the process of generation and transmission, which makes the beam deviate from the pointing and the quality of the spot becomes worse after long-distance transmission. These problems affect the measurement accuracy of the optical system, and in severe cases, they affect the normal operation of the system. To solve this problem, the commonly used methods are: reducing the vibration of the optical system or mechanical components to reduce the deviation of the beam; optimizing the optical design to reduce the distortion of the optical system itself; selecting a clean working environment to reduce the distortion introduced by the beam channel; keeping the optical system in a constant temperature environment to improve the effects of temperature changes, and so on. However, the conventional optical technology can not adapt to the ability of random environmental changes, nor can it eliminate the dynamic disturbances that change over time. Moreover, outside experimental site can not achieve a constant temperature and humidity environment. Therefore, dynamic disturbance is a problem that troubles the workers. In recent years, in order to solve the problem of random dynamic disturbance, adaptive optical technology has emerged as the times require, and has become one of the current extremely research directions in the field of optics. Adaptive optical systems are generally composed of wavefront sensors, deformable mirrors, and data acquisition controllers, and are used to improve the beam wavefront quality an optical system. Wherein the wavefront sensor and the data acquisition controller extract the wavefront information of the distorted spot and supply it to the deformable mirror, and the front phase of the beam is controlled by the deformation of the deformable mirror. This method has a good effect on improving the quality of the beam wavefront. However, this method improves the beam quality unilaterally and cannot solve the problem of beam divergence after long-distance transmission of the laser beam through multiple optical elements. Therefore, it is imperative to the key problems of beam collimation and quality optimization simultaneously.

### BRIEF SUMMARY

In order to solve the above technical problems, the present disclosure provides an adaptive beam collimation and quality optimization system and method based on spot gridding. Specifically, the offset amount and information of the distorted spot are obtained by combining spot gridding and image processing algorithm, and the adaptive beam collimation and quality optimization are realized by feeding back control through this information.

In order to achieve the above object, the present disclosure adopts the following technical scheme:
An adaptive beam collimation and quality optimization system based on spot gridding, the system comprises: a first optical reflector, a second optical reflector, an image collector, a computer, an X-axis piezoelectric ceramic module controller, a Y-axis piezoelectric ceramic module controller, a spot unit piezoelectric ceramic module controller, an X-axis piezoelectric ceramic module, a Y-axis piezoelectric ceramic module, and a spot unit piezoelectric ceramic array module and a three-module optical mirror frame,
wherein, the first optical reflector is installed at the front end of the three-module optical mirror frame, and the incident laser beam is reflected by the first optical reflector to reach the second optical reflector, and then the beam is output after being reflected by the second optical reflector again;
the X-axis piezoelectric ceramic module, the Y-axis piezoelectric ceramic module and the spot unit piezoelectric ceramic array module are mounted at the rear end of the three-module optical mirror frame; the X-axis piezoelectric ceramic module controller, the Y-axis piezoelectric ceramic module controller and the spot unit piezoelectric ceramic array module controller are used for controlling the X-axis piezoelectric ceramic module, the Y-axis piezoelectric ceramic module and the spot unit piezoelectric ceramic array module respectively;
the image collector is used to capture a spot image on the second optical reflector and store it to a computer;
the computer includes an image data processing system; the image data processing system is used to process the spot image collected by the image collector in real time, and to extract the real-time relative position the spot on the second optical reflector, rather than the relative position of the spot in the entire spot image; an offset of the spot is obtained by comparing the real-time relative position information with the calibration position, and the offset of the spot is fed back to the X-axis piezoelectric ceramic module controller and the Y-axis piezoelectric ceramic module controller, which are used to correct the offset of the output beam; an intensity information of the small unit spot is obtained after the extracted spot is gridded; calculating a weighted average intensity of the small unit spot adjacent to the distorted unit spot, and the difference between the distorted small unit spot intensity and the weighted average intensity is calculated, and the difference is fed back to the spot unit piezoelectric ceramic array module controller, which is used to correct the distortion of the output beam.

On the other hand, the present disclosure also provides an adaptive beam collimation and quality optimization method based on spot gridding, the method includes following steps:
firstly, the initial spot on the first optical reflector and the second optical reflector is gridded; the corresponding relationship is established among the small unit spot on the first optical reflector after gridding, a small module in the piezoelectric ceramic array module, and a small unit spot on the second optical reflector after gridding;
secondly, a spot image on the reflective surface of the second optical reflector is collected in real time, and the image processing is carried out to segment the spot and edge of the reflective surface of the second optical reflector;
finally, a relative position of the real-time spot on the second optical reflector is calculated, instead of the relative position of the spot on the entire spot image, and compared with the calibration position to obtain the offset amount and feed it back to the X-axis piezoelectric ceramic module controller and the Y-axis piezoelectric ceramic controller, which controls the forward and backward correction of the beam deviation of the X-axis piezoelectric ceramic module controller and the Y-axis piezoelectric ceramic module.

At the same time, the spot is gridded into a plurality of small unit spots, and the intensity information of the distorted small unit spot and the small unit spot adjacent to it is extracted; calculating a weighted average intensity of the small unit spot adjacent to the distorted small unit spot, and the difference between the distorted unit spot intensity and the weighted average intensity is calculated, and this difference is fed back to the spot unit piezoelectric ceramic array controller, which controls the forward and backward correction of the beam distortion in the spot unit piezoelectric ceramic array module of the three-module optical mirror frame corresponding to the distorted spot to correct the distortion of the output beam.

The beneficial effects of the present disclosure are as follows:
A method for correcting beam offset by extracting the relative position offset of the real-time spot is proposed, and a method for correcting beam distortion by extracting the intensity information of the small unit spot and its adjacent small unit spots through spot gridding is also proposed. The combination of the two methods can simultaneously correct the offset caused by random factors such as random vibration, air temperature and humidity change, atmospheric turbulence, and can compensate the distortion of the beam caused by atmospheric molecules, air suspended particles, aerosols, etc. The system based on the method can block random electrical signals, and it is also easy to achieve electromagnetic shielding, which can simultaneously achieve the adaptive collimation and quality optimization of the beam. And the system based on this method is also applicable to the collimation and spot size optimization of large diameter beams, which can be as large as dozens of millimeters. This system the advantages of small volume, easy installation, simple operation, low price, and no need for manual monitoring and operation.

### BRIEF DESCRIPTION OF THE SEVERAL VIEWS OF THE DRAWINGS

FIG. 1 shows an application framework diagram of an adaptive beam collimation and quality optimization system based on spot gridding of the present disclosure;

FIG. 2 shows a flowchart of an adaptive beam collimation and quality optimization method based on spot gridding of the present disclosure;

FIG. 3 shows a schematic diagram of the calibrated spot and spot offset on the reflective surface of the second optical reflector of the present disclosure;

FIG. 4 shows the energy column distribution of the intensity of the small unit spot corresponding to the aberrated spot after gridding of the present disclosure;

FIG. 5 shows a diagram of the deviation of the direction of the reflected light from the convex variation position of the reflecting surface of the first optical reflector of the present disclosure;

FIG. 6 shows a front view of the three-module optical mirror frame of the present disclosure;

FIG. 7 shows a back view of the three-module optics mirror frame of the present disclosure.

### DETAILED DESCRIPTION

In order to make the purpose, technical solution and advantages of the present disclosure more clear, the present disclosure will be further described in detail below in conjunction with accompanying drawings and the implementation examples. It should be understood that the specific embodiments described herein are only used to explain the present disclosure, and are not used to limit the present disclosure. In addition, the technical features involved in the various embodiments of the present disclosure described below can be combined with each other as long as they do not conflict with each other.

The present disclosure discloses an adaptive beam collimation and quality optimization system based on spot gridding, and FIG. 1 is a schematic diagram of present disclosure. The adaptive beam collimation and quality optimization system based on spot gridding of the present disclosure comprises: a first optical reflector 1, a second optical reflector 2, an image collector 3, a computer 4, an X-axis piezoelectric ceramic module controller 5, a Y-axis piezoelectric ceramic module controller 6, a spot unit piezoelectric ceramic array module controller 7, an X-axis piezoelectric ceramic module 8, a Y-axis piezoelectric ceramic module 9, a spot unit piezoelectric ceramic array module 10, and a three-module optical mirror frame 11;
wherein, the first optical reflector 1 is installed at the front end of the three-module optical mirror frame 11, and FIG. 6 shows front view schematic diagram of the three-module optical mirror frame 11. After the incident laser beam is reflected by the first optical reflector 1, it reaches the second reflector 2, and then outputs the beam; the X-axis piezoelectric ceramic module 8, Y-axis piezoelectric ceramic module 9, and spot unit piezoelectric ceramic array module 10 are installed at the rear end of the three-module optical mirror frame 11, and FIG. 7 shows a back view of the three-module optics mirror frame 11; the X-axis piezoelectric ceramic module controller 5, Y-axis piezoelectric ceramic controller 6, and spot unit piezoelectric ceramic array module controller 7 are respectively used to control the X-axis piezoelectric ceramic module 8, Y-axis piezoelectric ceramic module 9, and spot unit piezoelectric ceramic array module 10; the image collector 3 is used to collect the spot image output from the second optical reflector 2 and store it to the computer 4;
The computer 4 comprises an image data processing system, which is used for processing the real-time spot image captured by the image collector in real time and extracting the-time relative position of the spot on the second optical reflector 2; the offset of the spot is obtained by comparing the real-time relative position information with the calibration position information, and the offset of the spot is fed to the X-axis piezoelectric ceramic module controller 5 and the Y-axis piezoelectric ceramic module controller 6, and used for correcting the offset of the output light. The intensity information of the spot is extracted by image processing after the spot is gridded, and the intensity information of the distorted spot and its adjacent spot are fed back to the spot unit piezoelectric ceramic array module controller 7, which is used to correct the distortion of the emitted beam.

Further, the X-axis piezoelectric ceramic module 8, the Y-axis piezoelectric ceramic module 9, and the spot unit piezoelectric ceramic array module 10 are all provided with threads; the X-axis piezoelectric ceramic module controller 5, Y-axis piezoelectric ceramic module controller 6, and spot unit piezoelectric ceramic module controller 7 respectively control the forward and backward movement of the X-axis piezoelectric ceramic module 8, the Y-axis piezoelectric ceramic module 9, and the spot unit piezoelectric ceramic array module 10.

Further, the first optical reflector 1 can be a metal or optical glass, and its surface needs to be polished to ensure the surface reflectivity; the first optical reflector 1 needs to be a sheet.

Further, the image collector 3 can be a CCD, CMOS and other image collector, and the image collector 3 needs to capture a high definition color image with the spot on the reflection reflector instead of a black and white image.

Further, the spot unit piezoelectric ceramic array module 10 can be a square or round array, and the array needs to cover the spot.

Further, the relative position of the spot on the second optical reflector 2 is extracted by using an image processing method, instead of the relative position of the spot in the entire spot image.

Further, the initial position calibration of the spot on the second optical reflector 2 is required, and then the spot is monitored in real time, the real-time position information of the spot is extracted.

Further, three adjusters are installed at the rear end of the three-module optical mirror frame 11, which are used to adjust the X-axis piezoelectric ceramic module 8, Y-axis piezoelectric ceramic module 9, and the spot unit piezoelectric ceramic array module 10 respectively. The three modules, driven by the corresponding controllers to change the inclination and surface shape of the first optical reflector 1 installed at the front end of the three-module optical mirror frame, thus adjusting the X-axis offset, the Y-axis offset, and distortion of the reflected beam.

Further, when the laser beam is incident on the first optical reflector 1, it is reflected by the reflector and transmitted forward for a distance to reach the second reflector 2. Combined with this system and method, it can correct the offset of the spot caused by random factors such as random vibration, air temperature and humidity change, turbulence, and can also optimize the quality impact of atmospheric molecules, air suspended particles, aerosols, etc. on the beam.

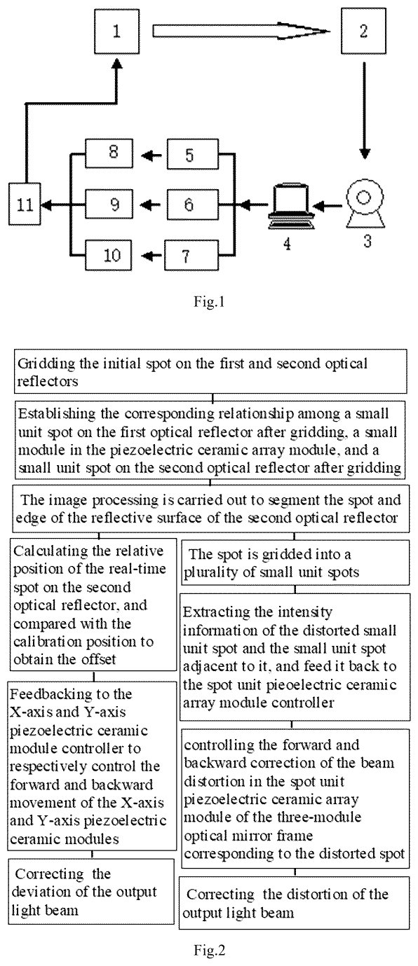

FIG. 2 shows a flowchart of an adaptive beam collimation and quality optimization method based on spot gridding of the present disclosure, and the specific process as following:

Firstly, the initial spot on the first optical reflector 1 and the second optical reflector 2 is gridded. The corresponding relationship is established among the small unit spot on the first optical reflector 1 after gridding, the small module in the piezoelectric ceramic ceramic array module 10, and the small unit spot on the second optical reflector 2 after gridding.

Secondly, the spot image on the reflective surface of the second optical reflector 2 is collected in real time, and the image processing is carried out to segment the spot and edge of the reflective surface of the second optical reflector 2.

Finally, the relative position of the real-time spot on the second optical reflector 2 is calculated and compared with the calibration position to obtain the offset. This offset is fed back to the X-axis piezoelectric ceramic module controller 5 and the Y-axis piezoelectric ceramic module controller 6, which control the forward and backward movement of the X-axis piezoelectric ceramic module 8 and the Y-axis piezoelectric ceramic module 9, and then adjust the inclination of the reflecting surface of first optical reflector 1, so as to realize the correction of the beam deviation.

At the same time, the spot is gridded into a plurality of small unit spots, and the intensity information of the distorted small unit spot and adjacent small unit spot is extracted and fed back to the spot unit piezoelectric ceramic array module controller 7. The spot unit piezoelectric ceramic array module controller controls the forward and backward movement of small module corresponding to the distorted spot in the spot unit piezoelectric ceramic array module 10 on the three-module optical mirror frame 11, which used to adjust the surface shape of the first optical reflection mirror 1, and then correct the distortion of the beam.

### Embodiment 1

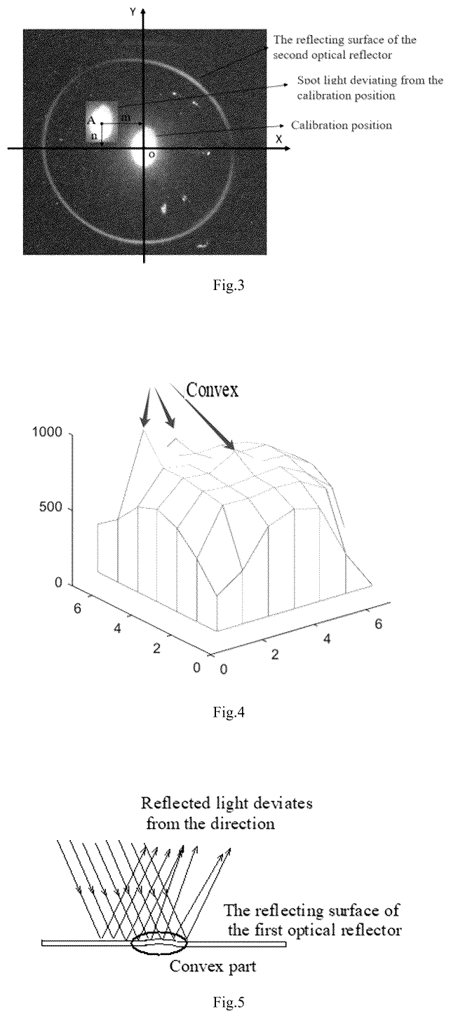

As shown in FIG. 3, the calibration spot and spot offset on the reflective surface of the second optical reflector 2 are given, the center of the spot coincides with the center of the reflector at the initial moment, and the coordinates of this position are marked as the origin (0, 0), and the position of the spot at this time is the calibration point. Real-time monitoring of the spot on the second optical reflector 2, if the spot deviates to the position of point A, the coordinates of the spot at this time are marked as (xₐ, yₐ). The image segmentation method is used to segment the edge contour of the reflector and the edge contour of the spot, and the real-time amount of the relative position x₀−x_{c}=m, y₀−y_{c}=n is calculated. Assuming that the distance between the first optical reflector 1 and the second optical reflector 2 is L. The distance between the X-axis piezoelectric ceramic modules 8 and Y-axis piezoelectric ceramic modules 9 in the three-module optical mirror frame 11 to the fixed point are both a, respectively. Then the X-axis piezoelectric ceramic module 8 needs to be set to a distance a*m/L ahead, and the Y-axis piezoelectric ceramic module 9 needs to be set a distance a*n/L ahead, and set the beam back to the position of the calibrated point to correct deviation of the beam. If m or n is negative, it represents moving backward.

### Embodiment 2

Firstly, the initial spot on the first optical reflectors 1 and second optical reflectors 2 are gridded. The corresponding relationship is established among the small unit spot on the first optical reflector 1 after gridding, the small module in the spot unit piezoelectric ceramic array module 10, and the small unit spot on the second optical reflector 2 after gridding.

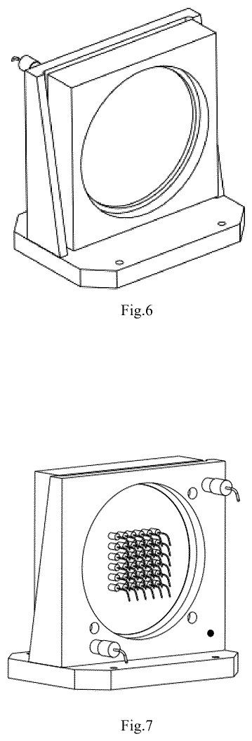

Secondly, the real-time spot image on the second optical reflector 2 is gridded, and the intensity information of the small unit spot is extracted. If the light spot is distorted, the spot will show irregular distribution and is represented by local convex distribution of small unit spot intensity energy column as shown in FIG. 4. The convex part is formed due to the local excessive concentration of beam energy caused by mirror surface, beam transmission medium and other issues. This phenomenon can be eliminated or alleviated by adjusting the curvature of the reflecting surface of the first optical reflector 1. Firstly, calculating the weighted average on the spot intensities of adjacent small unit spot of the convex energy column, and the difference between the protrusion intensity and the weighted average value is calculated. Secondly, the difference is fed back to the spot unit piezoelectric ceramic array module controller 7, and the spot unit piezoelectric ceramic array module controller will control the advancement of the small modules corresponding to the small unit spot with the energy intensity protuberance, and the surface of the first optical reflector 1 will produce a slight change correspondingly. Finally, this convex change will change the direction of the reflected beams on the reflector surface, as shown in FIG. 5, and thus change the energy distribution of spot on the second optical reflector 2. After multiple cycles of such optimization, the final regularly distributed spot is obtained, namely, the correction of beam distortion is realized.

The above specific embodiments further describe the purpose, technical solution and beneficial effects of the present disclosure in detail. It should be understood that the above description is only for specific embodiments of the present disclosure, and is not intended to limit the present disclosure. Any modification, equivalent replacement, improvement, etc., within the spirit and principle of the disclosure, shall be included in the protection scope of the present disclosure.

The various embodiments described above can be combined to provide further embodiments. Aspects of the embodiments can be modified, if necessary to employ concepts of the various embodiments to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. An adaptive beam collimation and quality optimization system based on spot gridding, comprising a first optical reflector, a second optical reflector, an image collector, a computer, an X-axis piezoelectric ceramic module controller, a Y-axis piezoelectric ceramic module controller, a spot unit piezoelectric ceramic array module controller, an X-axis piezoelectric ceramic module, a Y-axis piezoelectric ceramic module, a spot unit piezoelectric ceramic array module, and a three-module optical mirror frame;
wherein, the first optical reflector is installed at the front end of the three-module optical mirror frame, and an incident laser beam is reflected by the first optical reflector to reach the second optical reflector, and then the incident laser beam is output after being reflected by the second optical reflector again;
the X-axis piezoelectric ceramic module, the Y-axis piezoelectric ceramic module and the spot unit piezoelectric ceramic array module are mounted at the rear end of the three-module optical mirror frame; the X-axis piezoelectric ceramic module controller, the Y-axis piezoelectric ceramic module controller and the spot unit piezoelectric ceramic array module controller are used for controlling the X-axis piezoelectric ceramic module, the Y-axis piezoelectric ceramic module and the spot unit piezoelectric ceramic array module respectively;
the image collector is used to collect a spot image output from the second optical reflector and store it to the computer;
the computer includes an image data processing system; the image data processing system is used to process the spot image captured by the image collector in real time, and to extract the real-time relative position the spot on the second optical reflector, rather than the relative position of the spot in the entire spot image; an offset of the spot is obtained by comparing the real-time relative position information with the calibration position, and the offset of the spot is fed back to the X-axis piezoelectric ceramic module controller and the Y-axis piezoelectric ceramic module controller, which are used to correct the offset of an output beam; an intensity information of a small unit spot is obtained after the extracted spot is gridded; calculating a weighted average intensity of the small unit spot adjacent to a distorted unit spot, and the difference between the distorted small unit spot intensity and the weighted average intensity is calculated, and the difference is fed back to the spot unit piezoelectric ceramic array module controller, which is used to correct the distortion of the output beam.

2. The adaptive beam collimation and quality optimization system based on spot gridding according to claim 1, wherein the X-axis piezoelectric ceramic module, the Y-axis piezoelectric ceramic module and the spot unit piezoelectric ceramic array module are all provided with threads; and the corresponding X-axis piezoelectric ceramic module controller, the Y-axis piezoelectric ceramic module controller, and the spot unit piezoelectric ceramic array module controller respectively control the forward and backward of the X-axis piezoelectric ceramic module, the Y-axis piezoelectric ceramic module and the spot unit piezoelectric ceramic array module.

3. The adaptive beam collimation and quality optimization system based on spot gridding according to claim 1, wherein the first optical reflector and the second optical reflector are made of metal or optical glass.

4. The adaptive beam collimation and quality optimization system based on spot gridding according to claim 1, wherein the spot unit piezoelectric ceramic array module adopts a square or round array, and the spot unit piezoelectric ceramic array module must cover the spot.

5. The adaptive beam collimation and quality optimization system based on spot gridding according to claim 1, wherein the image collector is to collect high-definition color images of the laser spot on the reflector in real time.

6. The adaptive beam collimation and quality optimization system based on spot gridding according to claim 1, wherein the rear end of the three-module optical mirror frame is provided with three adjusters, namely an X-axis piezoelectric ceramic module, a Y-axis piezoelectric ceramic module and a spot unit piezoelectric ceramic array module; those three modules are driven by the corresponding controllers to change the inclination and surface shape of the reflector installed at the front end of the three-module optical mirror frame, and adjust a X-axis offset, a Y-axis offset, and a distortion of the reflected beam.

7. An adaptive beam collimation and quality optimization method based on spot gridding, comprising the following steps:
firstly, an initial spot on a first optical reflector and a second optical reflector is gridded; the corresponding relationship is established among a small unit spot on the first optical reflector after gridding, a small module in the piezoelectric ceramic array module, and a small unit spot on the second optical reflector after gridding;
secondly, a spot image on the reflective surface of the second optical reflector is collected in real time, and the image processing is carried out to segment the spot and edge of the reflective surface of the second optical reflector;
finally, a relative position of the real-time spot on the second optical reflector is calculated, instead of the relative position of the spot on the entire spot image, and compared with the calibration position to obtain the offset value and feed it back to the X-axis piezoelectric ceramic module controller and the Y-axis piezoelectric ceramic controller, which controls the forward and backward movement of the X-axis piezoelectric ceramic module and the Y-axis piezoelectric ceramic module to correct the deviation of the output beam;
at the same time, the spot is gridded into a plurality of small unit spots, and the intensity information of a distorted small unit spot and the small unit spot adjacent to it is extracted; calculating a weighted average intensity of the small unit spot adjacent to the distorted small unit spot; and the difference between the distorted small unit spot intensity and the weighted average intensity is calculated, and this difference is fed back to the spot unit piezoelectric ceramic array controller, which controls the forward and backward correction of the beam distortion in the spot unit piezoelectric ceramic array module of the three-module optical mirror frame corresponding to the distorted spot to correct the distortion of the output beam.
